(19) United States
(12) Patent Application Publication
(10) Pub. No.: US 2024/0256433 A1
(43) Pub. Date: Aug. 1, 2024

(54) COMPOSING EFFICIENT AND ROBUST TESTS TO ASSESS ARTIFICIAL AGENTS

(71) Applicant: Sony Group Corporation, Tokyo (JP)

(72) Inventors: Dustin Morrill, Edmonton (CA); Thomas J. Walsh, Boston, MA (US); Daniel Hernandez, Denver, CO (US)

(21) Appl. No.: 18/418,835

(22) Filed: Jan. 22, 2024

Related U.S. Application Data
(60) Provisional application No. 63/481,464, filed on Jan. 25, 2023.

(51) Int. Cl. G06F 11/36

(52) U.S. Cl. CPC G06F 11/3684

(57) ABSTRACT

Modern reinforcement learning systems produce many high-quality policies throughout the learning process. However, to choose which policy to actually deploy in the real world, they must be tested under an intractable number of environmental conditions. A process, called Robust Population Optimization for a Small Set of Test cases (“RPOSST”), can select a small set of test cases from a larger pool based on a relatively small number of sample evaluations. RPOSST can treat the test case selection problem as a two-player game and can optimize a solution with provable k-of-N robustness, bounding the error relative to a test that used all the test cases in the pool. Empirical results demonstrate that RPOSST finds a small set of test cases that identify high quality policies in a toy one-shot game, poker datasets, and a high-fidelity racing simulator.

### CROSS-REFERENCE TO RELATED APPLICATIONS

This application claims the benefit of priority of U.S. provisional patent application 63/481,464, filed Jan. 25, 2023, the contents of which are herein incorporated by reference.

### BACKGROUND OF THE INVENTION

### 1. Field of the Invention

Embodiments of the invention relate generally to systems and methods of selecting test cases for determining high quality policies for deployment in reinforcement learning systems for artificial agents.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Modern artificial intelligence (AI) systems often produce many high-quality agent policies in the “long tail” of the learning process. However, to choose which policy to deploy in the real world, there can be a very large number of possible environmental conditions to use to test the policies. Practitioners often generate many policies that perform well during training but which require thorough vetting on alternative conditions or opponents. Ideally, AI systems would construct a test case for every conceivable deployment scenario, evaluate each policy on each test case, and rank each policy according to a weighted average of test case results. However, such a procedure is typically infeasible because of the sheer numbers of policies and deployment scenarios, especially if test cases are lengthy or involve people.

Therefore, there is a need systems and methods for selecting for selecting a small number of test cases from a larger pool that minimizes the reduction in test quality.

### SUMMARY OF THE INVENTION

Aspects of the present invention provide apparatus and methods to implement techniques for selecting test cases for policies in reinforcement learning systems. In one implementation, a computer system using reinforcement learning develops multiple policies. The system selects multiple test cases from a set of test cases. The system uses iteration to review and improve the distribution of selected test cases. The system then uses the selected test cases with the developed policies to produce evaluation results for each policy. The system uses the evaluation results to select one or more of the tested policies.

Features provided in implementations can include, but are not limited to, one or more of the following items: analyzing the test case results of a small set of policies and finding a distribution over a subset of test cases to reconstruct test scores constructed from all test case results; iteratively improving the distribution over the test cases by receiving feedback about reconstruction error; receiving feedback about error from an adversary; and using the resulting distribution over the subset of test cases to score and rank any future reinforcement learning policies.

As used herein, the term “AI” refers to any functionality or its enabling technology that performs information processing for various purposes that people perceive as intelligent, and that is embodied by machine learning based on data, or by rules or knowledge extracted in some methods.

As used herein, the term “policy” describes a set of context dependent instructions to solve a control problem or play a game, potentially generated by a reinforcement learning (RL) algorithm. In some cases, the policy can be encoded as a neural network.

As used herein, the term “deployment policy” refers to a policy used in production, e.g., deployed to end users, used in a competition, or integrated into a technology demonstration.

As used herein, the term “deployment candidate” refers to a policy in consideration for deployment.

As used herein, the term “test” refers to a set of test cases.

As used herein, the term “test result” refers to the aggregate of the test case results.

As used herein, the term “test case” refers to an atomic unit of a test that reveals a particular skill or emulates a specific deployment scenario. Aspects of the present invention can select a small number of test cases and a distribution over them so that can avoid executing all conceivable test cases on every deployment candidate every time a policy is selected for deployment.

As used herein, the term “test case result” refers to the numerical result of evaluating a policy on a test case. This number should be a good estimate of the policy's expected performance in the test case scenario, but it may be noisy if the test case is stochastic, e.g., the average test case result observed from Monte Carlo rollouts.

As used herein, the term “test score” refers to the final score produced by a test, i.e., the average test case result across test cases, perhaps weighted by the relative importance of each test case.

As used herein, the term “tuning policy” refers to a policy used at the start of the process to gather information about test cases. Each tuning policy is evaluated on each test case to construct the test case result matrix that forms the basis of a loss function.

Embodiments of the present invention provide a computer-implemented method for determining a subset of test cases, selected from a set of test cases, that identify candidate deployment policies from a set of policies comprising evaluating each tuning policy of a subset of tuning policies, from the set of policies, with each test case, from the set of test cases, to generate a result matrix of test case results; utilizing a two-player game formulation for determining a loss function for each of m test cases sampled on each of N sampled policies from the set of policies; and selecting the subset of test cases based on a plurality of rounds of the two-player game formulation, wherein the subset of test cases are operable for determining the candidate deployment policies.

Embodiments of the present invention provide a method for selecting policies to use in a racing simulation comprising accessing, by a development server, a set of candidate policies, where each policy is a trained model stored in a policy database and represents at least one behavior for an agent operating a car in a racing simulation; selecting, by the development server, one or more tuning policies from the set of candidate policies; accessing, by the development server, a set of candidate test cases, where each test case is a collection of data stored in a test case database and represents at least one condition in an environment in the racing simulation; selecting, by the development server, one or more test cases from the candidate cases; first reviewing, by the development server, a performance of using the selected test cases with the tuning policies, where the first reviewing includes iteratively using machine learning; selecting, by the development server, one or more test cases as application test cases based on results of the first reviewing; second reviewing, by the development server, performance of using the application test cases with one or more candidate policies; and selecting, by the development server, one or more policies as deployment policies based on the results of the second reviewing.

Embodiments of the present invention provide a computer-implemented method for identifying candidate deployment policies from a set of policies comprising evaluating each tuning policy of a subset of tuning policies, from the set of policies, with each test case, from a set of test cases, to generate a result matrix of test case results; utilizing a two-player game formulation for determining a loss function for each of m test cases sampled on each of N sampled policies from the set of policies; selecting a subset of test cases based on a plurality of rounds of the two-player game formulation; and sampling the set of policies on the subset of test cases to determine the candidate deployment policies.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1A illustrates a representation of a process according to an embodiment of the present invention, where a result matrix A is constructed from rollouts;

FIG. 1B illustrates a representation of a process according to an embodiment of the present invention, where RPOSST analyzes A, and outputs an efficient robust test;

FIG. 1C illustrates a representation of a process according to an embodiment of the present invention, where new candidate deployment policies are tested against each test case and each result is weighted to produce a test score for each candidate deployment policy;

FIG. 2 illustrates a pictorial representation of RPOSST test construction as a two player game, according to an exemplary embodiment of the present invention;

FIG. 3 illustrates an exemplary algorithm for RPOSST_{SEQ} with regret matching+ and successive rejects;

FIGS. 4A and 4B illustrates an exemplary algorithm for deterministic CVaR(η) RPOSST_{SEQ} with regret matching+;

FIGS. 5A and 5B illustrate expected test score error (absolute difference) across holdout-policy-target-distribution pairs on Racing Arrows;

FIG. 5C illustrates expected test score error (absolute difference) across holdout-policy-target-distribution pairs on the 2012 two-player, limit competition of the ACPC;

FIG. 5D illustrates expected test score error (absolute difference) across holdout-policy-target-distribution pairs on the 2017 two-player, no-limit competition of the ACPC;

FIGS. 5E and 5F illustrate expected test score error (absolute difference) across holdout-policy-target-distribution pairs on Gran Turismo™ 7 races;

FIGS. 5G through 5I illustrate the Gran Turismo™ test results of candidate deployment policies against the test case pair most favored by RPOSST, where blue and red indicates positive and negative winrates respectively for a candidate deployment policy in a test case;

FIGS. 6A through 6C illustrate expected test score error across holdout-policy-target-distribution pairs on Racing Arrows where test cases are follower policies; and

FIG. 7 illustrates a functional block diagram illustration of a computer hardware platform that can be used to implement a particularly configured computing device that can create and use a process for finding a small set of test cases that identify high quality policies.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G, and the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a process, called Robust Population Optimization for a Small Set of Test cases (“RPOSST”), that can select a small set of test cases from a larger pool based on a relatively small number of sample evaluations. RPOSST can treat the test case selection problem as a two-player game and can optimize a solution with provable k-of-N robustness, bounding the error relative to a test that used all the test cases in the pool. Empirical results demonstrate that RPOSST finds a small set of test cases that identify high quality policies in a toy one-shot game, poker datasets, and a high-fidelity racing simulator.

In one application of one implementation, a game system uses a set of deployment policies in operating a game software application, such as PlayStation™ game console running a racing simulation game. For example, the policies could represent driving behaviors for system-controlled agents that operate cars in the racing simulation. The deployment policies are a subset of a set of candidate policies. A development server distributed the deployment policies to the game system after selecting the deployment policies from the candidate policies using test cases reflecting aspects of environments where the policies are used.

The development server and game system are computer systems, including processing, storage, and network hardware and software. The policies and test cases are represented by and stored as data in a computer system, such as data stored in one or more databases connected to the development server. The candidate policies represent a collection of policies that may be deployed by the development server. The candidate test cases represent a collection of test cases that define various environment conditions where policies may be applied, such as map conditions, weather conditions, and car conditions in a driving simulation.

The development server selects the deployment policies as a subset of the candidate policies to deploy using a subset of the candidate test cases. The development server selects a set of application test cases as a subset of the candidate test cases to apply, using the RPOSST process. In selecting test cases, the development server first uses a subset of the candidate policies as tuning policies. The development server uses the tuning policies and iterative reinforcement learning techniques to select the application test cases from the candidate test cases. The development server uses the application test cases with the candidate policies to evaluate the performance of the candidate policies. The development server uses the evaluation results to select the deployment policies from the candidate policies. In this way, the development server does not use all the candidate test cases to test all the candidate test policies. This reduction in testing can save time and resources in selecting policies for deployment. The development server can adjust the number of tuning policies and application test cases to adjust the time and resource requirements and the optimality of the evaluation of policies.

A goal of policy testing is to evaluate the strengths and weaknesses of a large set of candidate deployment policies, Π_{CDP}⊆┌, in order to choose one for deployment. A policy π∈Π in this setting can be any mapping from environment observations to a distribution over actions (e.g., Markov policies). A policy is evaluated on a test that includes various test cases chosen from a pool, T. Each test case simulates an important aspect of the deployment environment, for example, different parameter settings like weather conditions or different opponent policies in a competitive game. For straightforward comparisons between policies, a policy π's test results can be summarized with a scalar test score, computed as the weighted average of π's test case results according to test case weights, σ∈Δ^{|T|}.

If T is small, then right before deployment one could simply test each policy, rank the policies in Π_{CDP} according to the test scores, and deploy the best one. However, if policies will encounter a wide range of conditions during deployment, e.g., hundreds or thousands of different players for a policy deployed to a popular video game, then T ostensibly needs to be large in order to adequately reflect such diversity. The linear scaling in |T| presents not just a computational burden, but also costs in sample complexity (if the test cases are lengthy) or even in person-time if human quality assurance testers might be needed for test cases.

Aspects of the present invention address the problem of composing an efficient test, [symbol] τ, \check{σ}_{τ} [symbol] , by selecting a small number of test cases τ⊂T and test case weights \check{σ}∈Δ^{|τ|} to approximate a full test, [symbol] T, σ∈Δ^{|T|} [symbol] . Complicating this task are two sources of uncertainty to which the efficient test must be robust. First, [symbol] τ, \check{σ}_{τ} [symbol] ought to be used on new candidate deployment policies, so Π_{CDP} is unknown before [symbol] τ, \check{σ}_{τ} [symbol] is chosen. Second, the desired target distribution, σ, defining the full test to approximate may drift after [symbol] τ, \check{σ}_{τ} [symbol] is chosen.

Aspects of the present invention can assume access to a small set of representative tuning policies Π_{TNP} ⊂Π for immediate testing. Additionally, RPOSST can take, as input, a joint distribution Ψ over Π_{TNP} and Δ^{|T|} to represent the combined uncertainty about which policies the output test will be applied to and which target distribution to approximate.

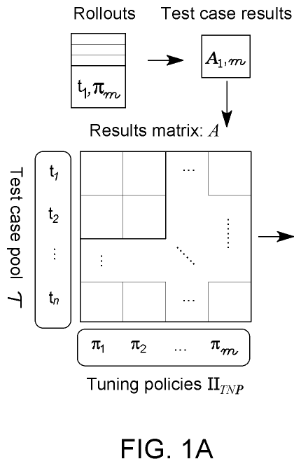

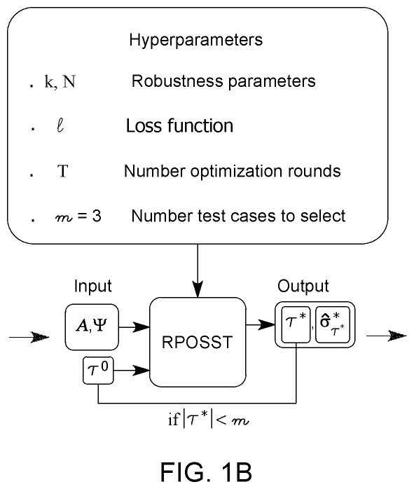

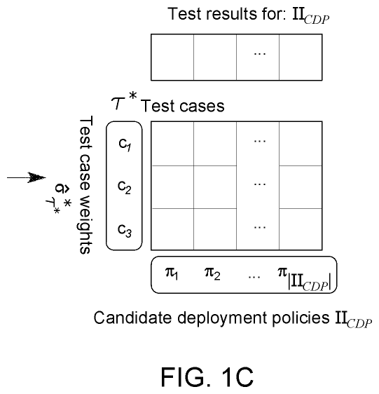

FIGS. 1A through 1C provide an illustration of the test composition pipeline for policy testing with RPOSST. From FIG. 1A to FIG. 1C, the result matrix A is constructed from rollouts, i.e., A_{i,j} is the average rollout outcome for tuning policy j (Π_{TNP} is the set of tuning policies) on test case i. RPOSST analyzes A, taking into account uncertainty distribution Ψ and a (possibly empty) initial set of test cases that must be used, τ⁰. RPOSST outputs an efficient robust test [symbol] τ*, \check{σ}*_{τ*} [symbol] , here using only m=3 test cases (if T is too large to select all 3 test cases at once, τ* can be fed back into RPOSST as τ⁰). New candidate deployment policies, Π_{CDP}, are tested against each test case in τ* and each result is weighted according to \check{σ}*_{τ*}, producing a test score for each candidate deployment policy.

As a concrete example of the terms above and the need for robustness in the face of uncertainty, consider a car-racing agent developed for a one-on-one racing game. The first source of uncertainty is over the future policies that may be desired to be tested. Consider the case where, at test construction time, policies are available from two training runs—one that produces aggressive (collision-prone) policies, and another that produces more polite policies, but there is uncertainty about which type will be best suited for the game. In this case, the selected test cases should provide good evaluations on policies from either set, and thus require Ψ to reflect this uncertainty. Policies from both sets should be included in Π_{TNP} and RPOSST needs to be robust to policies within Π_{TNP}.

A second source of uncertainty is over which test cases are most important. Imagine that there are provided some test cases that specifically target and penalize off-track infractions. In the future, game designers could request fewer infractions or allow for more risky racing lines. To hedge against both of these possibilities, two target distributions can be added to Ψ, one where off-track tests cases have higher weights than the other test cases, and another where they have lower weights. The job of an algorithm (such as RPOSST) is then to ensure its tests are accurate according to both target distributions.

In order to compose an efficient and robust test, established game-theoretic frameworks can be utilized for modeling robustness and learning optimal decisions (specifically, regret minimization). The following subsections present material on these two topics.

### Robustness

The idea of robustness is to prepare for an unfavorable portion of possible outcomes sampled from an uncertainty distribution. In the formulation of policy testing, the uncertainty distribution covers the future policies in Π_{CDP} and the target distribution. A percentile robustness measure, μ, is a formal representation of a robustness criterion as a probability distribution over percentiles. For example, if μ has all of its weight on 0.01, then an m-size test with weights \check{σ}_{τ} that is robust according to μ, then the test minimizes test score error on \check{σ}_{τ}'s worst 1% of policy-target-distribution pairs sampled from Ψ.

The k-of-N robustness measures are percentile robustness measures defined by parameters k, N∈ [symbol] , 1≤k≤N, that permit tractable optimization procedures. This parameterization reflects the mechanics of how an efficient test [symbol] τ, \check{σ}_{τ} [symbol] is evaluated on such a measure: N policy-target-distribution pairs are sampled from Ψ and σ_{T}'s performance is averaged over the k worst pairs for \check{σ}_{τ}. Every k-of-N robustness measure is a non-increasing function, i.e., more weight is placed on smaller percentiles, and the fraction k/N represents the percentile (technically the fractile) around which the measure decreases.

In the test construction setting according to aspect of the present invention, the choice of k and N reflects the designer's tolerance for test scores that are bad because of “unlucky” outcomes from Ψ (that is, test scores with large error on policy-target-distribution pairs sampled from Ψ, even if they are sampled infrequently). Optimizing for performance under small percentiles (e.g., setting k=1, N=100) yields tests with a small maximum test score error across Π_{TNP}. Then, even if each candidate deployment policy resembles the tuning policy that has the largest test score error, the optimized test will yield small test score errors. In contrast, optimizing for the uniform measure (k=N) optimizes for mean performance across Π_{TNP}, essentially assuming Π_{CDP}=Π_{TNP}, which can lead to large test score error on the actual candidate deployment policies.

As N→∞, the k-of-N robustness measure approaches the conditional value at risk (CVaR) robustness measure at the k/N fractile, which evenly weights all of the fractiles≤k/N and puts a weight of zero on all larger fractiles. Formally, the robustness optimization objective is to minimize the percentile performance loss:

$${L}_{μ , Ψ} ( {\hat{σ}}_{τ} ) = {inf}_{y ∈ γ} \int y ( η ) μ ( d η ) , \qquad ( 1 )$$

$$η ∈ [ 0 , 1 ] , ℙ [ ℓ ( {\hat{σ}}_{τ} ; π , σ ) \leq y ( η ) ] \geq η$$

under a loss function [symbol] : Δ^{|T|}×Π_{TNP}×Δ^{|T|}→ [symbol] where [symbol] is overloaded for incomplete test case weight vectors by filling in zeros for missing elements, [symbol] π, σ [symbol] ˜Ψ, and y is the class of real-valued, bounded, μ-integrable functions on [0, 1]. An efficient (m-size) μ-robust test is a minimizer of L_{μ,Ψ} across all \check{σ}_{τ} where τ=m.

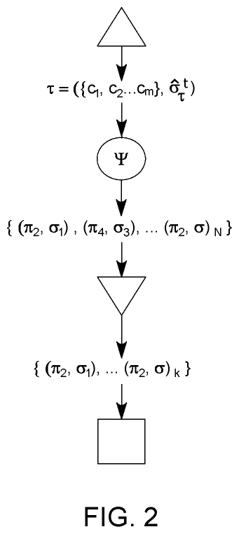

As illustrated in FIG. 2, the optimization of the percentile performance loss under k-of-N robustness measure, μ_{k-of-N}, can be modeled as a zero-sum imperfect information game.

Here, a protagonist player constructs efficient tests and an antagonist chooses a tuning policy to test and a target distribution. In the upper triangle, the protagonist constructs a test [symbol] τ^{t}, \check{σ}_{τ}^{t} [symbol] by selecting test case and learning weights. As shown in the following circle of FIG. 2, nature can draw N samples. For their payoffs, the antagonist receives the test score error of the protagonist's test given the antagonist's tuning policy and target distribution while the protagonist receives the negation. The k and N parameters determine which target distributions and tuning policies that the antagonist can choose from and how many pairs must be averaged across. At the start of the game, N target-distribution-tuning-policy pairs are sampled. From these N pairs, the antagonist must select k of them, as shown in the lower triangle in FIG. 2. Finally, one of these k pairs is sampled, both players receive their payoffs, and the game ends. A minimax test for the protagonist, i.e., one that minimizes the protagonist's maximum loss in this game is a μ_{k-of-N}-robust test.

It should be noted that deterministic CVaR(h) RPOSST_{SEQ}, used in the experiments discussed below, fixes the ratio of h=k/N (e.g. 1%). The adversary selects pairs until the cumulative probability reaches h.

### Regret

While the game above models the optimization process, it does not instruct the protagonist on how to choose test cases to win. A no-regret online decision process (ODP) algorithm can find approximate minimax decisions by repeatedly playing out the game and improving over time from payoff feedback. Formally, on each round t of the game, an ODP algorithm chooses an efficient test [symbol] τ^{t}, \check{σ}_{τ}_{^{t}}^{t} [symbol] and receives the payoff function vₜ=—∇_{\check{σ}}_{^{t}}_{T}_{^{t}} [symbol] (\check{σ}_{τ}_{^{t}}^{t}; π^{t}, σ^{t}) as feedback given [symbol] π^{t}, σ^{t} [symbol] chosen by the antagonist. If the antagonist always plays a best response to the ODP algorithm, that is, the tuning-policy-target-distribution pair that maximizes the loss of \check{σ}_{τ}_{^{t}}^{t} on each round t ∈{1, . . . , T}, T≥1, then the no-regret property ensures that at least one of the tests in the sequence [symbol] [symbol] τt, \check{σ}_{τ}_{^{t}}^{t} [symbol] [symbol] ₜ₌₁^{T} is at most O(G/\sqrt{T}) away from the minimax value, where G>0 is the maximum magnitude of the loss gradient.

Regret matching is a no-regret algorithm for simplex decision sets, e.g., the m-dimensional test case weight space Δm, that selects

$${\hat{σ}}_{{τ}^{t}}^{t} = \frac{{q}^{1 : t - 1}}{{1}^{T} {q}^{1 : t - 1}}$$

using pseudoregrets q^{1:t}=[q^{1:t-1}+ρ^{t}]+, q^{1:0}=0, where ρ^{t}=v^{t}−(v^{t})^{T}\check{σ}_{τ}_{^{t}}^{t} is the instantaneous regret vector

$$( {\hat{σ}}_{{τ}^{t}}^{t} = \frac{1}{d} 1$$

if none of the pseudoregrets are positive).

### RPOSST

According to aspects of the present invention, robust population optimization for a small set of test cases (RPOSST) begins by evaluating each tuning policy π∈Π_{TNP} on each test case c∈T, yielding a |T|×|Π_{TNP}| result matrix A of test case results. As an optimization approach, RPOSST aims to minimize prediction errors, as measured by a convex function Δ: [symbol] × [symbol] → [symbol] , e.g., the absolute difference Δ(\check{x}, x)=|\check{x}−x|. RPOSST robustly optimizes for a small set of test cases and a weighting over them according to how well it reproduces test scores admitted by A as measured by a loss function

$$ℓ : \hat{σ} ; {π}_{j} , σ ↦ Δ ( {\underbrace{{E}_{i ∼ σ} [ {A}_{i , j} ]}}_{σ ' s test score for {π}_{j} .} , {\underbrace{{E}_{i ∼ σ} [ {A}_{i , j} ]}}_{σ ' s test score for {π}_{j} .} ) ,$$

on test case distribution \check{σ}∈Δ^{|T|} compared to \check{σ}∈Δ^{|T|} with respect to test results from the j^{th} tuning policy πⱼ. Since \check{σ} is being used to produce test scores that approximate those under σ, σ can be called a target distribution in this context. One goal is to select a small number of test cases, so RPOSST can be constrained to output weights \check{σ}_{τ}∈Δ^{m} for groups of test cases τ⊂T of size m.

Though T is large, the cost of computing A is balanced by the savings of using fewer test cases for future policies. RPOSST is robust to any distribution over Π_{TNP}, so as long as this set covers the space of Π_{CDP} (i.e., all π∈Π_{CDP} are convex mixtures of Π_{TNP}), this robustness imparts a minimum test accuracy guarantee even on deployment candidates. Intuitively, this means the quality of RPOSST's tests will tend to improve with more diverse tuning policies. Accordingly, it should be beneficial for a tuning policy to represent an extreme point in a reasonable region of policy space, or at least for it to be generated with a method similar to that which will generate deployment candidates (e.g., sampled from checkpoints of RL training runs). That way, the tuning policies include a diverse collection of skilled and unskilled policies with random variations, while retaining architectural and algorithmic similarities to future deployment candidates.

Following the earlier discussion of k-of-N robustness, the optimization in RPOSST can be framed as a zero-sum game. By adversarially choosing policies to test, the antagonist forces RPOSST to compose tests that are better at accurately testing the more difficult-to-assess policies in the tuning set, providing a degree of robustness to the distribution of future deployment candidates. Similarly, by adversarially choosing the target distribution, the antagonist also forces RPOSST to be robust along this dimension. The steps of each round t=1, . . . , T of the optimization game are as follows: (1) The protagonist must choose an m-tuple of test cases τ^{t} ⊂T and weights \check{σ}_{T}_{^{t}}^{t}∈Δ^{m}. (2) N policies to test and target distributions, [symbol] [symbol] πⱼ_{ᵢ}, σᵢ [symbol] [symbol] ᵢ₌₁^{N}, are sampled from uncertainty distribution Ψ. (3) The antagonist chooses the k worst policies and target distributions, i.e., those that maximize [symbol] (\check{σ}_{T}_{^{t}}^{t}; πⱼ_{ᵢ}, σᵢ). (4) One of the k worst configurations is sampled uniformly, leading to the end of the round, at which point the protagonist receives the payoff v_{T}_{^{t}}_{,(i)}^{t}=− [symbol] (\check{σ}_{T}_{^{t}}^{t}; πⱼ_{₍ᵢ₎}, σ₍ᵢ₎), where the subscript (i) denotes the i^{th} element of a sorted list in descending order (the i^{th} worst for the protagonist).

The protagonist is allowed to update their strategy at the end of each round based on the expected payoff, [symbol] _{i˜U}_{_{nif}}_{({1, . . . k})}[u_{T,(i)}^{t}], for each τ∈T^{m} they could have chosen. The more rounds of the game that are run (the larger T is), the closer RPOSST gets to returning a minimax strategy, and consequently, a robust optimal selection of test cases and weights. Thus, in application, T can be set as large as is convenient under computational and time constraints. Although the protagonist must consider an exponential (in m) number of test case combinations, the premise of RPOSST is that a small set of test cases is desired, so m will be small. To decrease computational requirements, RPOSST can be run in a loop to select test cases iteratively until m have been selected, at a potential cost to test accuracy compared to optimizing for the entire m-tuple at once.

### Antagonist Information Models

Two RPOSST algorithm variants are considered that utilize different models of the information that the antagonist in the optimization game has before they make their choice. These models correspond to two policy testing use cases. The first, “simultaneous move” model is less pessimistic, but has impractical aspects, which are addressed by the subsequent “sequential move” model.

Simultaneous move. The simultaneous move model is a naïve application of the original k-of-N game. In this model, the antagonist does not observe which m-tuple of test cases, T^{t}, is selected by the protagonist on each round t. Instead, it is randomized with a distribution \check{σ}_{T}^{t}∈Δ|T|^{m}. This model corresponds to the policy testing use case where a new m-tuple of test cases is sampled independently for each test that is performed. Every test only evaluates m cases, as desired from a computational efficiency perspective, however, the particular test cases used in each test could be different, making results incomparable across tests.

Sequential move. In the sequential move model, the antagonist observes τ^{t} before acting. The antagonist is thus able to tailor their choice of [symbol] [symbol] πⱼ₍ᵢ₎, σ₍ᵢ₎ [symbol] [symbol] ᵢ₌₁^{k} to whichever τ^{t} is selected, and randomizing over the m-tuple of test cases has no benefit to the protagonist. Since the antagonist observes τ^{t}, the protagonist must update all the weights that they would apply to each test case tuple τ as if τ^{t}=τ. Thus, the selection of τ^{t} does not impact the protagonist's updates and there is no need to explicitly select an m-tuple until the very end of the algorithm, after T′˜Unif({1, . . . , T₁}) rounds.

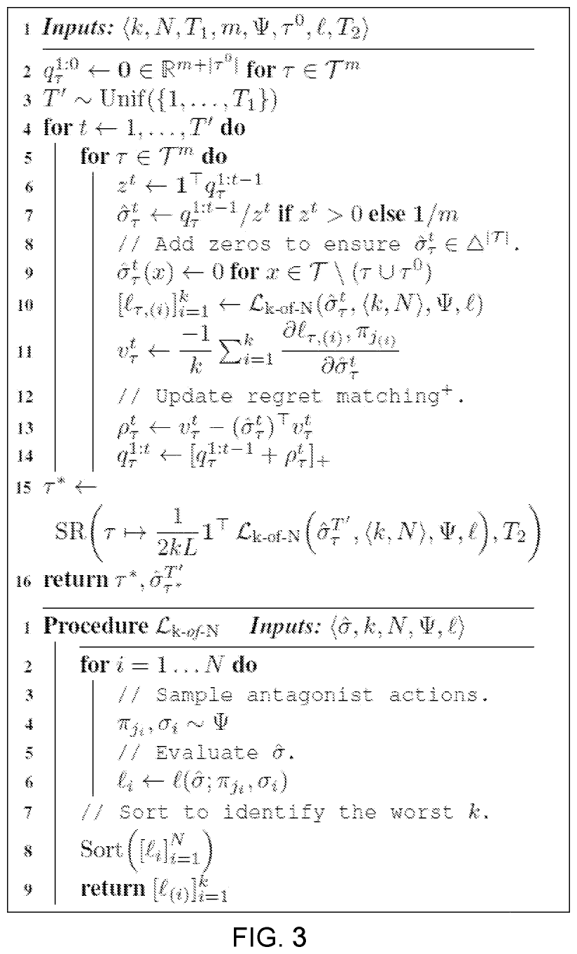

Since the set of N losses observed on each round are generally random, they cannot be reused to identify which m-tuple leads to the lowest loss using the test case weights computed after running for T′ rounds, [symbol] \check{σ}_{τ}^{T′} [symbol] τ∈T^{m}. In addition, expected k-of-N losses cannot be accessed directly; they need to be estimated by sampling from Ψ. Therefore, the selection of a single τ is a “best arm identification” problem, where T^{m} is the set of arms. The Successive Rejects (SR) algorithm is an exploration-only bandit algorithm that can be used to solve this problem with a worst-case guarantee on the probability that it identifies the best arm. The more SR iterations that are run, the more likely it is to select the best arm. Algorithm 1, in FIG. 3, shows how to implement RPOSST for the sequential move model using regret matching+ for tuning the test case weights and SR for the final selection of an m-tuple.

In specific applications, an example of which will be described below, an optimization game can be constructed so that it is deterministic, and consequently, SR can be replaced with a simple argmax.

The RPOSST_{SEQ} objective is the percentile performance loss

$${min}_{{τ ∈ {T}^{m}}_{στ ∈ {Δ}^{m}}} {inf}_{y ∈ γ} \int y ( η ) {μ}_{k - of - N} ( d η ) , \qquad ( 2 )$$

$$n ∈ [ 0 , 1 ]$$

$$ℙ [ ℓ ( {\hat{σ}}_{τ} ; {π}_{j} , σ ) \leq y ( η ) ] \geq η$$

where [symbol] πⱼ, σ [symbol] ˜Ψ.

The sequential move model represents the policy testing use case where m test cases are selected and fixed and test case weights for all future test policies. Test scores are easily reproducible and comparable across test applications since the test cases never change.

Theorem 4.1. After T′˜Unif({1, . . . , T₁}), T₁>0, rounds of its optimization game, Algorithm 1 selects an m-tuple of test cases, τ* and weights \check{σ}_{τ*}^{T′}∈Δ^{m} that, with probability (1−p)(1−q)(1−α), p, q, α>0, are ε/q-optimal for Equation (2), where

$$ε = O ( \sqrt{\frac{1}{{T}_{1}} m} + \sqrt{\frac{1}{{T}_{1}} log ( \frac{1}{p} )} ) and α = O ( {e}^{- {T}_{2}} ) .$$

In the extreme case where Π_{TNP} covers Π, then this optimality result, (in terms of an upper bounded percentile loss integral), extends to all deployment candidates Π_{CDP}.

### Deterministic CvaR RPOSST

While in general, an RPOSST algorithm has a randomized procedure and a non-deterministic optimality guarantee, hyperparameters can be selected so that RPOSST is deterministic, making the procedure simpler and more reliable. If the ratio k/N is fixed and N→∞, the k-of-N robustness measure converges toward the CVaR measure at the k/N fractile. A k-of-N algorithm where N→∞ cannot be implemented with the usual sampling procedure, but it can be implemented if the distribution characterizing the uncertainty, Ψ, has finite support.

Sampling Ψ infinitely would result in sampling all tuning-policy-target-distribution pairs in its support exactly in proportion to their probabilities. Rather than selecting k tuning-policy-target-distribution pairs, the antagonist must select pairs until their cumulative probability sums to k/N. Effectively, the antagonist assigns weights

$${α}_{( i )} = min \{ Ψ ( 〈 {π}_{{j}_{( i )}} , {σ}_{( i )} 〉 ) , k / N - {\sum }_{h = 1}^{i - 1} {α}_{( h )} \}$$

to each tuning-policy-target-distribution pair in Ψ's support, where the ordering between pairs is determined by the loss each induces for the protagonist. Finally, these tuning-policy-target-distribution pairs are sampled according to the normalized weights α(i)N/k.

The robustness guarantees become deterministic because the entire RPOSST algorithm, denoted as CVaR(η) RPOSST for the η=k/N fractile, can be run using exact expectations (excluding randomness in A, which is taken as given in RPOSST). Determinism in RPOSST_{SEQ} allows for directly checking the exact expected loss of each test case distribution on each round, letting the tracking on the lowest loss test case distribution across all rounds. This tracking, in turn, allows for the avoidance of both sampling T′ and running the SR algorithm to do the final selection. Instead, the process can simply return the lowest loss test case distribution across all T rounds.

If there are d tuning-policy-target-distribution pairs in Ψ's support, then the expected CVaR(η) loss of the protagonist on round t is

$${L}^{t} = {min}_{τ ∈ {T}^{m}} {\sum }_{i = 1}^{d} \frac{{α}_{( i )}}{η} ℓ ( {\hat{σ}}_{τ}^{t} ; {π}_{{j}_{( i )}} , {σ}_{( i )} ) .$$

The round with the lowest expected loss is t*=arg min_{t∈{1, . . . , T}}L^{t}, and this definition allows stating the following corollary.

Corollary 4.2. Assume that Ψ∈Δ^{d} for some finite d≥1. After T rounds of the CVaR(η) RPOSST_{SEQ} optimization game, where the protagonist chooses m-size tests according to regret matching+ against a best response antagonist, τ* and σ_{τ*}^{t*} are ε-optimal for Equation (2) under the η-fractile CVaR robustness measure, where

$$ε = O ( \sqrt{\frac{1}{{T}_{1}} m} ) .$$

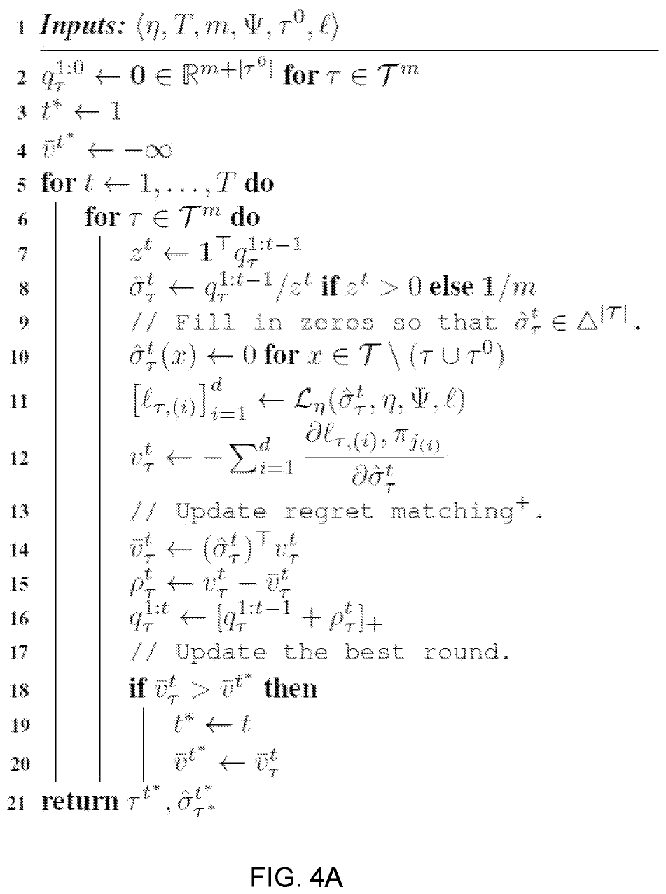

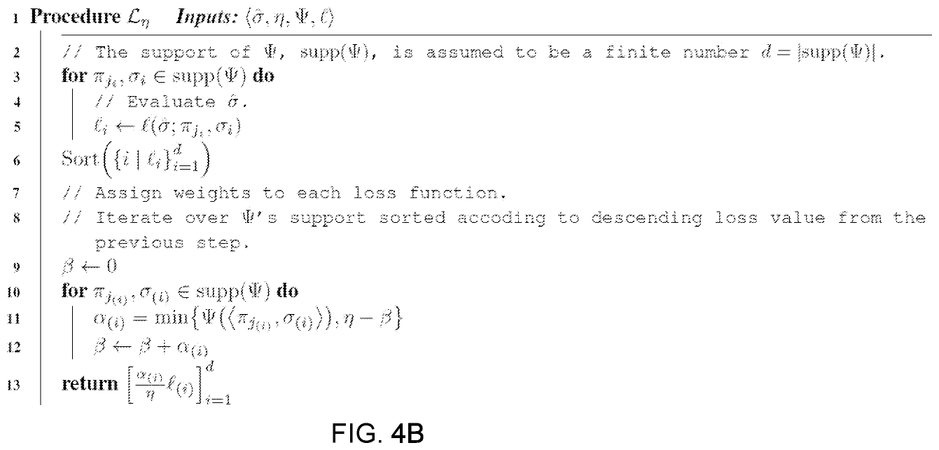

Pseudocode for CVaR(η) RPOSST_{SEQ} is presented in Algorithm 2, presented as FIGS. 4A and 4B.

In addition, a series of ablations of CvaR RPOSST_{SEQ} can be constructed to act as baselines for experiments, and to make a connection to the test-construction literature.

CVaR RPOSST_{SEQ} generalizes an intuitive algorithm: find the m-tuple of test cases that minimizes the maximum error assuming a uniform distribution over the tuple. This minimax uniform algorithm is implemented by executing only the initialization and selection steps of CVaR(0) RPOSST_{SEQ} (T=0). Further simplifying, minimax(TTD) uniform performs the antagonist maximization only over target distributions and assumes a uniform distribution over tuning policies. Minimax(TNP) uniform performs the antagonist maximization only over tuning policies and assumes a uniform target distribution. Miniaverage uniform assumes both a uniform distribution over tuning policies and for the target distribution.

Additionally, test cases could be selected one at a time to minimize the maximum error, echoing greedy algorithms from the test-construction literature. This iterative minimax algorithm is almost the same as running the initialization and return steps of CVaR(0) RPOSST_{SEQ} to select a single test case in a loop. The sole difference being that iterative minimax could select the same test case multiple times within its loop to adjust the test case weighting away from uniform.

### EXPERIMENTAL

CVaR RPOSST_{SEQ}'s performance was explored in three two-player games spanning the range of complexity from a toy one-shot game to a high-fidelity racing simulator, in comparison with minimax and miniaverage baselines. It was shown that robustness does tend to decrease test score errors on holdout policies and that RPOSST specifically either outperforms or performs about as well as each baseline in each domain.

### Experimental Setup

In each domain, the experimental setup starts with data from playing out every pairing of n>0 policies, yielding a matrix of scores for the column policy. Each policy along the rows of this matrix is then treated as a test case, making the score at row i and column j the result of evaluating policy j on test case i.

To emulate unknown deployment candidate policies to be tested, h>0 columns of this matrix are held out and the policy associated with a holdout column is called a holdout policy. The remaining columns represent the test case results for the set of tuning policies. The resulting n×(n−h) matrix is shifted and rescaled so that all entries are between zero and one, and then it is set as the test result matrix A that the methods take as input. It should be noted that, although h test cases are generated by holdout policies, as test cases they cannot provide any special information about what tests would be effective on the holdout policies. To simulate scenarios where the set of tuning policies covers the set of future candidate deployment policies to varying degrees, experiments were run with three different values of h: 0.2n, 0.4n, and 0.6n. One hundred different holdout sets are randomly sampled for each value of h and in each domain.

Given results for n test cases, the goal is to produce a distribution over m<n test cases that provides accurate test results on the set of holdout policies, according to a set of target distributions. For the experiments, m∈{1, 2, 3} was used and the set of target distributions generated from the softmax function were applied to the negative average test case result under four different scales, specifically,

$$exp ( \frac{- β}{n} A 1 ) / {1}^{T} exp ( \frac{- β}{n} A 1 )$$

for β∈{0, 1, 2, 4}, so that the distributions put varying degrees of emphasis on test cases that are more difficult on average across the tuning policies. The RPOSST uncertainty distribution, Ψ, was set to be uniform over each tuning-policy-target-distribution pair. The CVaR percentile was set to 1% so that it is nearly optimizing for the worst-case, but is slightly less pessimistic, to add an additional distinguishing factor to RPOSST compared to the minimax and minaverage baselines. The absolute difference loss was used for both optimization and evaluation.

### Domains

RPOSST was tested on the following three domains of varying complexity. Each domain has two variants arising from asymmetry, multiple datasets, or alternative scoring rules.

Racing Arrows. Racing Arrows is a two-player, zero-sum, one-shot, continuous action game invented for the experiments to replicate aspects of a passing scenario in a race featuring a “leader” player and faster “follower” player. The follower tries to pass the leader while the latter tries to block. Scores are recorded as 0 or +1 for a loss or win, respectively, for the column player, which is either the leader or the follower, depending on the configuration. RPOSST was run on both configurations. For the experiments, 50 or 500 different leader and follower policies evenly spread through the valid policy space, angles in [0, π], were sampled by taking 50 or 500 evenly spaced angles between [0.05π, (1-0.05)π] and then shifting them independently with uniform samples in [−0.05π, 0.05π].

Annual Computer Poker Competition. Two open datasets from the Annual Computer Poker Competition (ACPC) were used, containing pairwise match data for poker agents submitted to the 2017 two-player, no-limit competition and the 2012 two-player, limit competition. These competitions contain different agent populations since they are separated by five years and are in different game formats (limit and no-limit). The 2017 competition includes 15 agents and the 2012 competition includes 12 agents. Scores were recorded as chip differentials of duplicate matches (two sets of hands where players play with the same set of shuffled decks in both seats).

Gran Turismo™ one-on-one races. Gran Turismo™ 7 (GT) is a high fidelity racing simulator on the PlayStation™ platform. Previous versions of GT served as benchmarks for training RL policies, including policies that outraced the best human competitors in four-on-four racing. A simpler one-on-one racing scenario was considered, where two experiments were carried out, one where test case results are average win rates, and another where policies receive 0 for a loss, +1 for a win, and −1 if there was a collision, making the game non-zero-sum. The test case pool is comprised of 43 trained RL policies and 3 built-in “AI” policies.

### Results and Analysis

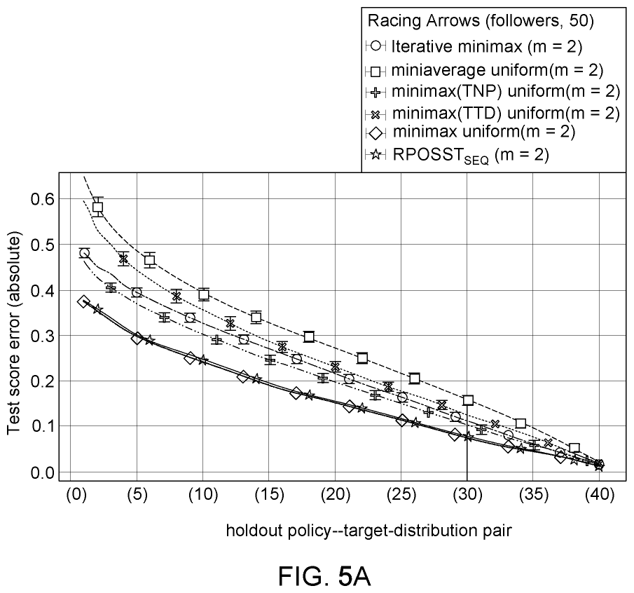

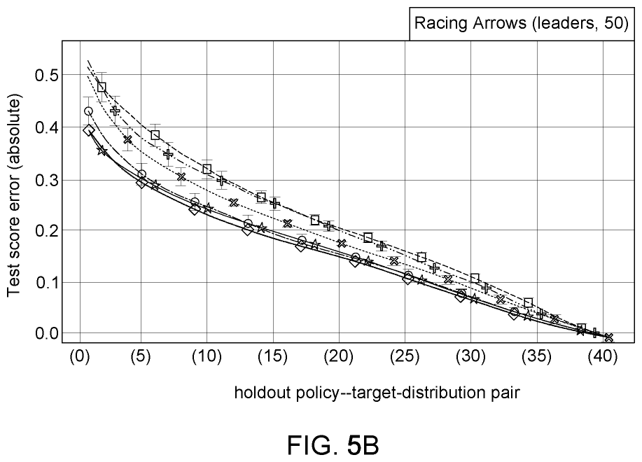

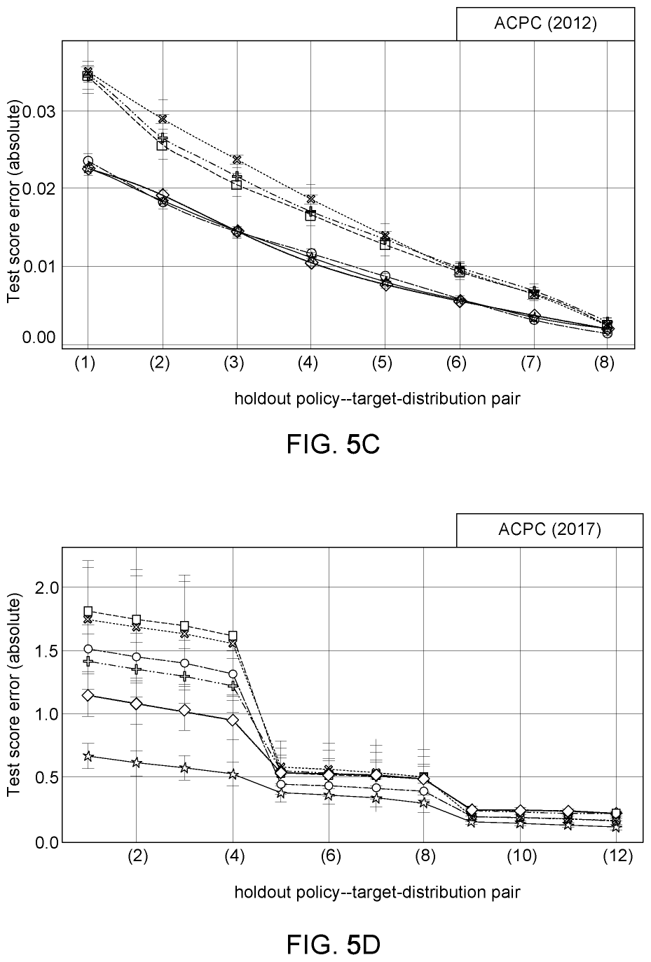

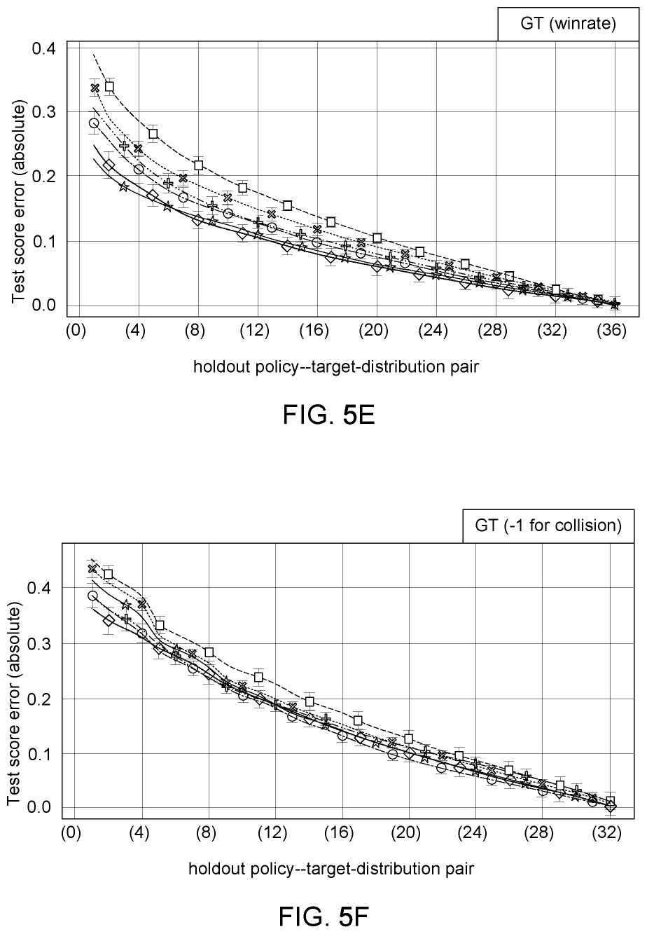

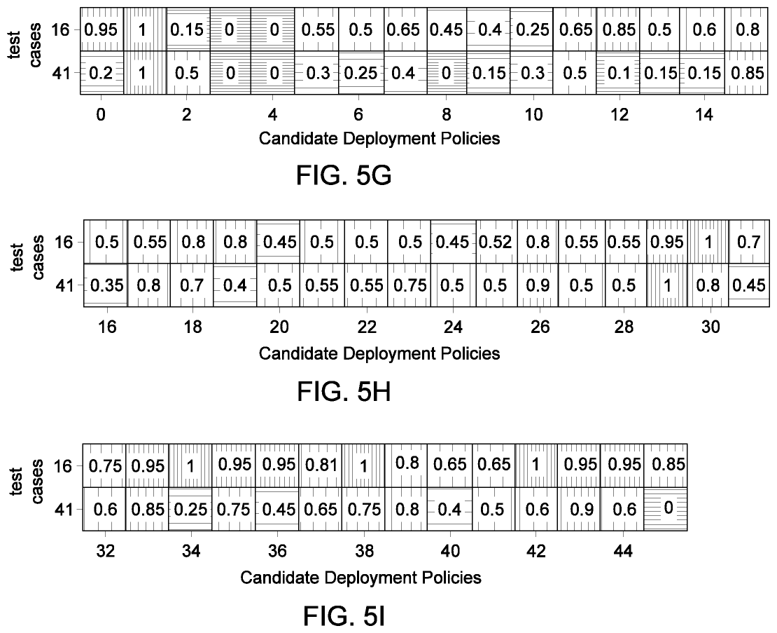

The results of running CVaR(1%) RPOSST_{SEQ} on each domain, with m=2 and 20% of policies marked as holdout policies, are shown in FIGS. 5A through 5F. The same set of figures with m=1 and m=3, as well as 40% and 60% holdout policies, are qualitatively similar, except that the differences between the algorithms are typically smaller.

FIGS. 4A through 4F show expected test score error (absolute difference) across holdout-policy-target-distribution pairs on (FIGS. 5A and 5B) Racing Arrows, (FIG. 5C) the 2012 two-player, limit competition of the ACPC, (FIG. 5D) the 2017 two-player, no-limit competition of the ACPC, (FIGS. 5E and 5F) Gran Turismo™ 7 races, between CVaR(1%) RPOSST_{SEQ} and baseline tests on 100 randomly sampled sets of holdout policies (20% of the full set of policies; 80% used as tuning policies). Holdout-policy-target-distribution pairs are sorted according to test score error. Each RPOSST_{SEQ} instance was run for 500 rounds (T=500). Error bars represent 95% t-distribution confidence intervals.

Looking across each domain and variant, it can be seen that RPOSST_{SEQ} performs nearly as well or better than all of the minimax and miniaverage baselines, particularly in terms of maximum error across holdout-policy-target-distribution pairs. Interestingly, RPOSST_{SEQ} has noticeably lower error in ACPC 2017 and GT (winrate) on the four most difficult holdout-policy-target-distribution pairs to accurately evaluate. The improvement over the next best method is substantial in ACPC 2017 because RPOSST is the only method with an unlimited ability to optimize with a non-uniform test case weighting. On the other variant in each domain, RPOSST_{SEQ} is within the group of the lowest error methods. In the two Racing Arrows domains, RPOSST_{SEQ} and minimax uniform substantially outperform the other methods, at least on the most difficult holdout-policy-target distribution pairs. This result shows that robustness is indeed beneficial here, but the uniform distribution over the selected two opponents happens to be quite effective. The GT variant where −1 is assigned to a collision appears to be more difficult than the winrate variant, as all the methods cluster together in this variant at higher errors than in the winrate variant.

These results illustrate the utility of incorporating robustness generally, as all of the robust methods tend to outperform miniaverage uniform. Minimax uniform and iterative minimax are the only baselines that minimize their maximum error over both tuning policy and target distribution uncertainty, and they are usually the next best methods after RPOSST_{SEQ}. Minimax(TNP) uniform typically outperforms minimax(TTD) uniform, showing that it is more important to be robust to the tuning policy than the target distribution, in these domains. When the target distributions are the same in the optimization and holdout evaluation phases, robustness should directly improve the minimum performance across holdout realizations. Since no effort was made to enforce any relationship between the tuning and holdout policies, this result suggests that robustness to the tuning policy can yield large error reductions when Π_{TNP} are even somewhat similar to the holdout policies.

As an example of RPOSST's capabilities, consider the pairs of opponent policies chosen as test cases in GT (winrate) over 100 experiment seeds. RPOSST_{SEQ} is both more accurate (FIGS. 5A through 5F) and very consistent, choosing the same pair 90% of the time. As shown in FIGS. 5G through 5I, the Gran Turismo™ test results of candidate deployment policies against the test case pair most favored by RPOSST, where blue and red indicates positive and negative winrates respectively for the candidate deployment policy in a test case. In FIGS. 5G through 5I, the vertical lined backgrounds represent a blue color and the horizontal lined backgrounds represent a red color, where the closer the spacing of the lines represents a darker shade color.

The race against policy 41 (bottom row) was chosen because that policy wins/loses about half the time, providing a 50/50 information split. Policy 16 is a weaker policy in many ways (more blue color (vertical lines), in the top row), but it serves to differentiate the worst policies (darker red squares (more closely spaced horizontal lines) in the left side of the matrix) from the rest of the policies, and to highlight the strongest policies. Specifically, the best performing policies almost always win against policy 16, which provides a strong complementary signal to the noisier but more competitive policy 41 test case. Overall, the two test cases indicated policies 1, 29, and 43 (darkest blue (most closely spaced vertical lines) columns) are the strongest for deployment. Policy 1 is a built-in AI in an overpowered car but 29 and 43 are very strong RL policies. Similar decisions would be made using the full set of 46 test cases. Compressing from 46 test cases to two presents a massive saving in test time for future policies, and shows RPOSST_{SEQ} can construct small tests to select deployment policies in a real and complex video game.

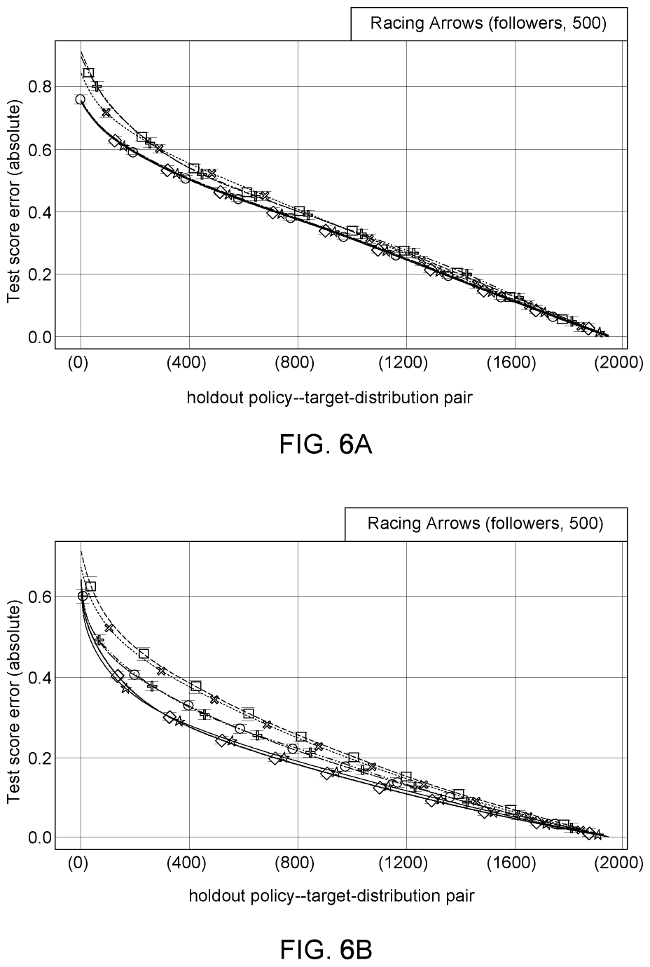

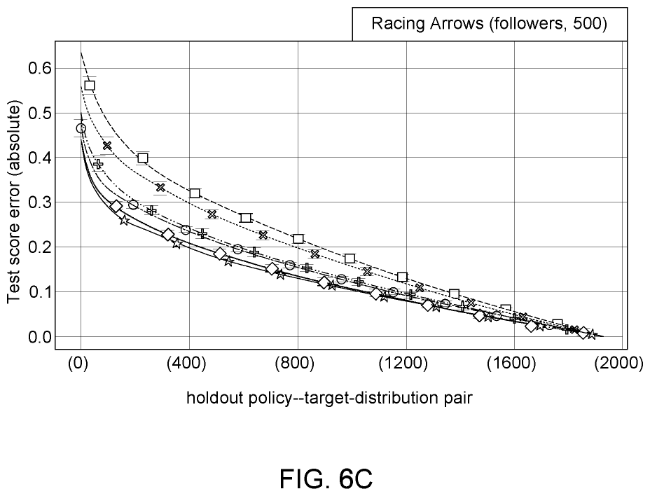

The results in FIGS. 6A through 6C repeat the previous analysis in Racing Arrows but with ten times the number of policies.

In FIGS. 6A through 6C, expected test score error across holdout-policy-target-distribution pairs on Racing Arrows are shown, where test cases are follower policies. Here, 500 Racing Arrows policies were sampled for both the follower and leader role and then 96% of policies of both roles were held out before running RPOSST and each baseline. Each column uses a different test size m. One hundred sets of holdout policies were sampled and each RPOSST_{SEQ} instance was run for 500 rounds (T=500).

Only the results where follower policies are treated as test cases are shown, but the corresponding results where leader policies are test cases appear similar. 96% of policies are held out, including those used as test cases, so there are only 20 test cases and tuning policies for RPOSST and the other algorithms to utilize. This experiment emulates a scenario where an efficient test is constructed once with a relatively small number of tuning policies and then reused for many future deployment candidates. As in the previous experiments, RPOSST is almost always one of the best methods.

### CONCLUSIONS

RPOSST is the first algorithm to directly address test construction for reinforcement learning policies. By leveraging the k-of-N framework, RPOSST provides bounds on the approximation error of the resulting test despite uncertainty over the exact policies that will be evaluated and the desired test case weighting in the future. Thus, RPOSST provides a much needed tool for policy selection in real-world deployment scenarios.

### Exemplary System

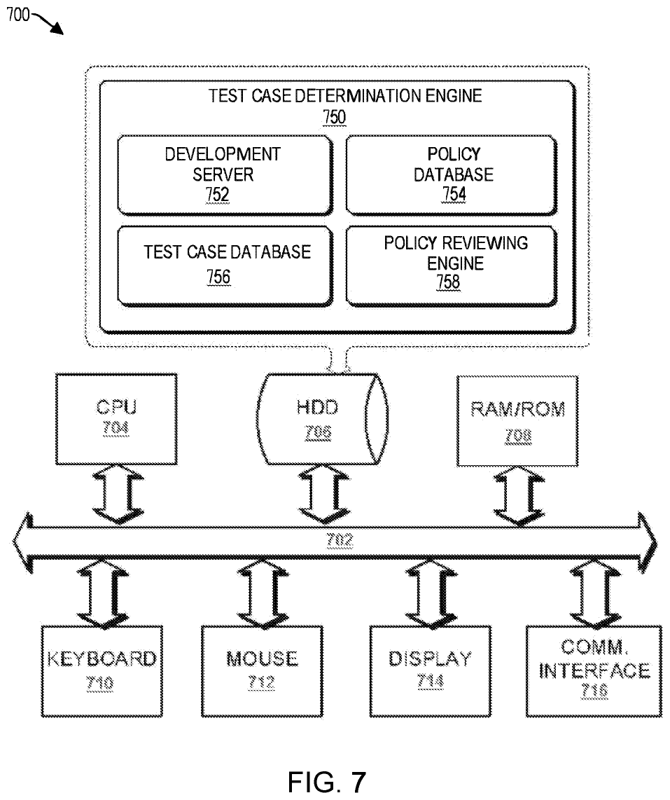

FIG. 7 provides a functional block diagram illustration of a computer hardware platform 700 that can be used to implement a particularly configured computing device that can host an test case determination engine 750. The test case determination engine 750, as discussed above, can find a small set of test cases that identify high quality policies. The test case determination engine 750 can include a development server 752, operable to send/receive and process data, a policy database 752 containing a plurality of candidate policies, a test case database 754 containing a plurality of test cases for testing the policies, and a reviewing engine 754, operable to review the policies by applying a test case thereto and determining the test case results.

The computer platform 700 may include a central processing unit (CPU) 702, a storage medium, such as a hard disk drive (HDD) 704 or a solid state drive, for example, random access memory (RAM) and/or read only memory (ROM) 706, a keyboard 708, a mouse 710, a display 712, and a communication interface 714, which are connected to a system bus 716.

In one embodiment, the HDD 704 has capabilities that include storing a program that can execute various processes, such as the test case determination engine 750, in a manner to perform the methods described herein.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A computer-implemented method for determining a subset of test cases, selected from a set of test cases, that identify candidate deployment policies from a set of policies, comprising:
evaluating each tuning policy of a subset of tuning policies, from the set of policies, with each test case, from the set of test cases, to generate a result matrix of test case results;
utilizing a two-player game formulation for determining a loss function for each of m test cases sampled on each of N sampled policies from the set of policies; and
selecting the subset of test cases based on a plurality of rounds of the two-player game formulation, wherein the subset of test cases are operable for determining the candidate deployment policies.

2. The computer-implemented method of claim 1, wherein the two-player formulation includes:
choosing an m-tuple of test cases, from the set of test cases, and weights for each of the m-tuple of test cases;
sampling N policies to test and target distributions for each of the N policies from an uncertainty distribution;
choosing the k worst policies and respective target distributions that maximize the loss function; and
sampling one of the k words policies and respective target distribution to provide a payoff.

3. The computer-implemented method of claim 1, wherein the selected test case and the tuning policy choice are performed simultaneously.

4. The computer-implemented method of claim 1, wherein the selected test case and the tuning policy choice are performed in sequence.

5. The computer-implemented method of claim 1, wherein the selected test case and the tuning policy choice are performed in sequence and hyperparameter values and constraints are applied, resulting in deterministic behavior.

6. The computer-implemented method of claim 1, wherein the tuning policies are selected from a reinforcement learning process.

7. The computer-implemented method of claim 1, wherein the tuning policies are selected to include a collection of skilled and unskilled policies with random variations.

8. The computer-implemented method of claim 1, wherein the tuning policies are selected with architectural and algorithmic similarities to future development candidate policies.

9. The computer-implemented method of claim 2, wherein the target distribution is based on a fixed uniform distribution over the m-tuple of test cases.

10. The computer-implemented method of claim 2, wherein test case selection is robust against differences between the tuning policies and the candidate deployment policies.

11. The computer-implemented method of claim 2, wherein test case selection is robust against differences between the target distribution used during training and an actual target distribution.

12. The computer-implemented method of claim 1, further comprising determining a weighting for each of the subset of test cases.

13. The computer-implemented method of claim 12, wherein the weighting on each of the subset of test cases is determined by expert guidance.

14. The computer-implemented method of claim 1, wherein the candidate deployment policies are policy for an artificial agent in a competitive racing simulation.

15. A method for selecting policies to use in a racing simulation, comprising:
accessing, by a development server, a set of candidate policies, where each policy is a collection of data stored in a policy database and represents at least one behavior for an agent operating a car in a racing simulation;
selecting, by the development server, one or more tuning policies from the set of candidate policies;
accessing, by the development server, a set of candidate test cases, where each test case is a collection of data stored in a test case database and represents at least one condition in an environment in the racing simulation;
selecting, by the development server, one or more test cases from the candidate cases;
first reviewing, by the development server, a performance of using the selected test cases with the tuning policies, where the first reviewing includes iteratively using machine learning;
selecting, by the development server, one or more test cases as application test cases based on results of the first reviewing;
second reviewing, by the development server, performance of using the application test cases with one or more candidate policies; and
selecting, by the development server, one or more policies as deployment policies based on the results of the second reviewing.

16. The method of claim 15, where the first reviewing includes using a protagonist and an adversary.

17. The method of claim 15, further comprising sending the deployment policies to a game system.

18. A computer-implemented method for identifying candidate deployment policies from a set of policies, comprising:
evaluating each tuning policy of a subset of tuning policies, from the set of policies, with each test case, from a set of test cases, to generate a result matrix of test case results;
utilizing a two-player game formulation for determining a loss function for each of m test cases sampled on each of N sampled policies from the set of policies;
selecting a subset of test cases based on a plurality of rounds of the two-player game formulation; and
sampling the set of policies on the subset of test cases to determine the candidate deployment policies.

19. The computer-implemented method of claim 18, further comprising determining a weighting for each of the subset of test cases.

20. The computer-implemented method of claim 18, wherein the tuning policies are selected to include a collection of skilled and unskilled policies with random variations.
